(19) United States
(12) Patent Application Publication
(10) Pub. No.: US 2011/0043520 A1
(43) Pub. Date: Feb. 24, 2011

(54) GARMENT FITTING SYSTEM AND OPERATING METHOD THEREOF

(75) Inventor: CHAO-TSUNG FAN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/849,788

(22) Filed: Aug. 3, 2010

(30) Foreign Application Priority Data
Aug. 21, 2009 (CN) 200910305925.6

(51) Int. Cl. G06T 17/00; G06F 17/30

(52) U.S. Cl. 345/420; 707/802; 707/E17.044

(57) ABSTRACT

A garment fitting system comprises a database module, a fitting module, a display module, and a model module. The database module is configured for storing garment information, the fitting module is configured for selecting garment images from the database module, and the display module is configured for displaying the result of garment images applied to a model.

### BACKGROUND

1. Technical Field

The present application is related to software applications, especially to a garment fitting system and a method thereof.

2. Description of Related Art

People may have difficulty choosing what to wear every day, especially when a departure time is approaching, and pressure to make a decision is increasing. A virtual garment fitting system addressing the described limitations is desired.

### BRIEF DESCRIPTION OF THE DRAWINGS

FIG. 1 is a block diagram showing one embodiment of a garment fitting system as disclosed.

FIG. 2 is a block diagram showing a storage unit of the system of FIG. 1.

FIG. 3 is a block diagram showing an operation interface of the system of FIG. 1.

FIG. 4 is a flowchart illustrating a garment fitting method as disclosed, according to an embodiment.

### DETAILED DESCRIPTION

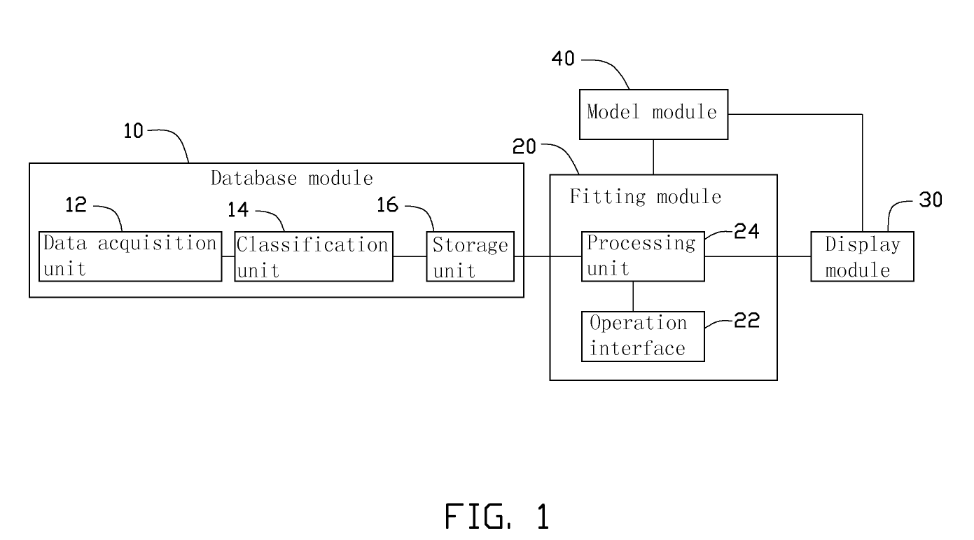

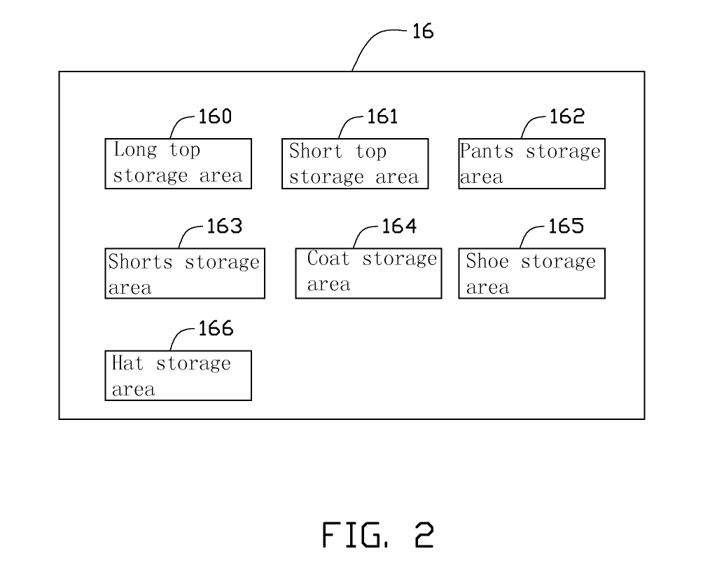

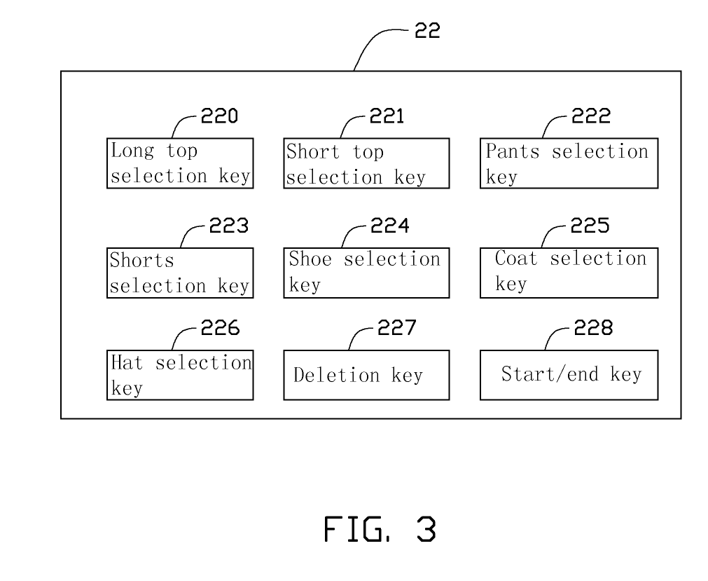

Referring to FIG. 1 to FIG. 3, one exemplary embodiment of a garment fitting system 1 comprises a database module 10, a fitting module 20, a display module 30, and a model module 40. The database module 10 is configured for storing garment information, the fitting module 20 is configured for selecting garments from the database module 10 and applying the selected garments to a selected model in the model module 40, and the display module is configured for displaying the combination result of the selected garment with the selected model.

The database module 10 comprises a data acquisition unit 12, a classification unit 14 and a storage unit 16. The data acquisition unit 12 is configured for capturing images of garments provided, and can be embodied as a camera module. The classification unit 14 is configured for classifying the garments provided based on the information captured by the data acquisition unit 12 according to garment types, such as upper garments, long pants, short pants, jackets, shoes, and hats, etc., and storing the classified information into the storage unit 16. The storage unit 16 comprises a long top storage area 160, a short top storage area 161, a pants storage area 162, a shorts storage area 163, a coat storage area 164, a shoe storage area 165, and a hat storage area 166. Other categories are possible depending on need.

The fitting module 20 comprises an operation interface 22, and a processing unit 24. The operation interface 22 provides multiple garment selection keys and functional selection keys. The garment selection keys comprise a long top selection key 220, a short top selection key 221, a pants selection key 222, a shorts selection key 223, a shoe selection key 224, a coat selection key 225, and a hat selection key 226. The functional keys comprise a deletion key 227 and a start/end key 228. The garment selection keys of the operation interface 22 correspond to the storage areas of the storage unit 16 through the processing unit 24. The deletion key 227 is configured for deleting unwanted garments of the storage unit 16. The start/end key 228 is configured for starting and ending the fitting system. The start/end key 228 and the deletion key 227 are both connected to the processing unit 24 for processing. The display module 30 is configured for displaying models and selected garments.

The model module 40 is configured for storing and showing one or more models, and is connected to the fitting module 20 and the display module 30. Each model is generated based on parameters input by users, consisting of a variety of measurements, such as breast sizes, waist sizes, hip sizes, etc. The model module can generate various user characteristics, such as an adult male model, an adult female model, a child male model, and a child female model, etc.

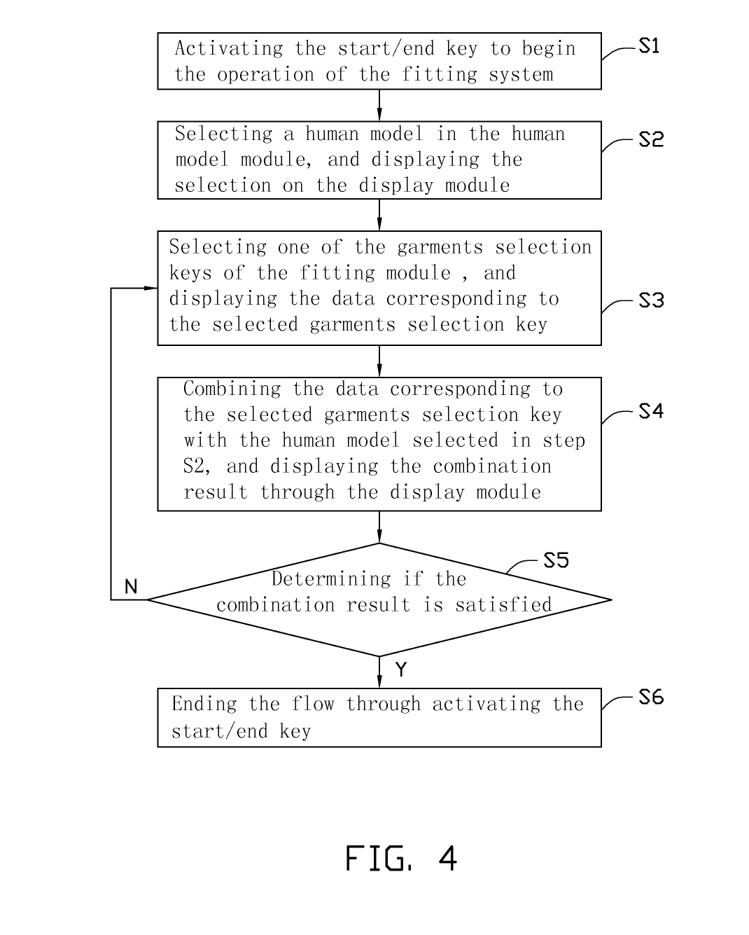

Referring to FIG. 4, a flowchart illustrates an exemplary method for operating the fitting system of the present application. In step S1, the start/end key is activated to begin the operation of the fitting system. In step S2, a model in the model module 40 is selected, and displayed by the display module 30. In step S3, one of the garment selection keys of the fitting module 20 is selected, and data corresponding to the selected garment selection key is displayed on the display module 30. In step S4, the data corresponding to the selected garment selection key is combined with the model selected in step S2, and the combined result is displayed on the display module 30. It is determined whether the combination result is acceptable in step S5. If the combination result is not acceptable, the step S3 is repeated, and if the combination result is acceptable, the step S6 is implemented. In step S6, the flow is ended via activation of the start/end key.

In an exemplary operation of the fitting system of the present application, a user initializes the fitting system by activation of the start/end key 228, and selects a model in the model module 40. Further a long top image is selected from the long top storage area 160 by activation of a long top selection key 220, a shorts image is selected from the shorts storage area 163 through a shorts selection key, and a shoe image is selected from the shoe storage area 164 by activation of the shoe selection key 224. The selected images are combined with the selected model and displayed by the display module 30. If the combined result is unacceptable for the user, the foregoing selection process is repeated until the combined result is acceptable. Once the combined result is determined, the fitting system is ended by activation of the start/end key 228.

The exemplified garment fitting system can be developed with JAVA language, and can be easily combined with operation systems of a personal computer, a cell phone, or any portable digital device. Therefore, the exemplified fitting room is convenient for users, and users can save lots of time to decide which combination of garments he/she wears.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A garment fitting system, comprising:
a database module including a data acquisition unit, a classification unit, and a storage unit;
a fitting module comprising an operation interface and a processing unit;
a model module including models generated by input measurements of a user; and
a display module;
wherein the data acquisition unit of the database module acquires digital information of garments, the classification unit classifies the digital information of garments into groups according to features of garment types, and the storage unit stores digital information corresponding to the groups classified by the classification unit; the operation interface of the fitting module comprises multiple garment selection keys for selecting classified garments; the processing unit of the fitting module applies the selected garments on the models; and the display module displays the result of applying the selected garments on the models.

2. The system as claimed in claim 1, wherein the data acquisition unit is a camera.

3. The system as claimed in claim 1, wherein the operation interface further comprises a start/end key for controlling activation and termination of the system.

4. The system as claimed in claim 1, wherein the operation interface further comprises a deletion key for controlling deletion of unwanted digital information from the storage unit.

5. A garment fitting method, comprising:
providing a garment fitting system comprising a database module, a fitting module, a model module, and a display module;
selecting a model from the model module;
selecting garment selection keys of the fitting module;
combining data corresponding to selected garment selection keys with the selected model through the fitting module;
displaying the combined result on the display module.

6. The method as claimed in claim 5, wherein the fitting module further comprises an operation interface and a processing unit, and the operation interface further comprises garment selection keys for selecting data corresponding to garments from the storage unit through the processing unit.

7. The method as claimed in claim 5, wherein the operation interface further comprises a deletion key controlling deletion of unwanted digital information from the storage unit.

8. The method as claimed in claim 5, wherein the model module is connected to the fitting module and the display module, and stores models generated by input measurements of the user.
